(19) United States
(12) Patent Application Publication
(10) Pub. No.: US 2005/0196127 A1
(43) Pub. Date: Sep. 8, 2005

(54) Port for an electronic device

(76) Inventors: Adam R. Cole, Mundelein, IL (US); Christopher P. Carlson, Mundelein, IL (US); Benjamin M. Finney, Barrington, IL (US)

Correspondence Address: MOTOROLA INC, 600 NORTH US HIGHWAY 45, ROOM AS437, LIBERTYVILLE, IL, 60048-5343, US

(21) Appl. No.: 11/072,882

(22) Filed: Mar. 3, 2005

Related U.S. Application Data
(60) Provisional application No. 60/550,626, filed on Mar. 5, 2004.

(51) Int. Cl. G02B 6/00

(52) U.S. Cl. 385/147

(57) ABSTRACT

An acoustic chamber (220, 222) and port (104, 202) for an electronic device are disclosed. A loudspeaker (204, 206) is coupled to port through the acoustic chamber. A port (104, 202) passes at least light from the chamber. A light element (224, 226) is carried within the acoustic chamber to emit light from the light port.

### CROSS REFERENCE TO RELATED APPLICATIONS

This application claims the benefit of U.S. Provisional Application No. 60/550,626, filed on 5 Mar. 2005, and entitled PORT FOR AN ELECTRONIC DEVICE, the disclosure of which is incorporated herein by reference.

### FIELD OF THE INVENTION

The present invention relates generally to ports for electronic devices and more particularly to an acoustic and lighting port for an electronic device.

### BACKGROUND OF THE INVENTION

Portable electronic devices, such as cellular telephones and personal digital assistants (PDA's) provide information to users through an increasing number of modalities, including graphical information displayed on display screens, sound played through speakers, and vibrations generated via vibratory components. In addition to display screens, visual information may be presented through lighting elements integrated into or underneath the surface of a device's housing. These lighting elements may include light emitting diodes (LED's), electro-luminescent (EL) panels, polymer dispersed liquid crystal (PDLC) light valves, or various other components. The lighting elements, in at least some instances, can be used to provide aesthetic lighting, variations in color, situational lighting effects, visual synchronization with music, visual ring tone alerts, visual indications of amplitude and frequency of ambient noise, and/or visual indications of battery or signal strength.

The typical means for incorporating lighting into a product is to use a lighting element with a dedicated light-guide system. This requires components and space allocations to get adequate brightness and uniformity of light, and it makes the design of the product more complicated. Effectively accommodating additional functionality into these small electronic devices in this manner is particularly challenging.

The present inventors have found that it is desired to provide more effective and creative method of accommodating lighting in an electronic device.

### BRIEF DESCRIPTION OF THE DRAWINGS

Features and advantages of the invention are evident from the following description of one or more embodiments of this invention, with reference to the accompanying drawings.

FIG. 1 is a perspective view of an exemplary electronic device;

FIG. 2 is a cross sectional view of the electronic device taken along plane II-II in FIG. 1;

FIG. 3 is an exploded portion III of the cross sectional view of FIG. 2; and

FIG. 4 is a block diagram of a wireless communication device.

### DETAILED DESCRIPTION

While the present invention is susceptible of embodiment in various forms, there is shown in the drawings and will hereinafter be described several embodiments with the understanding that the present disclosure is to be considered an exemplification of the invention and is not intended to limit the invention to the specific embodiments illustrated.

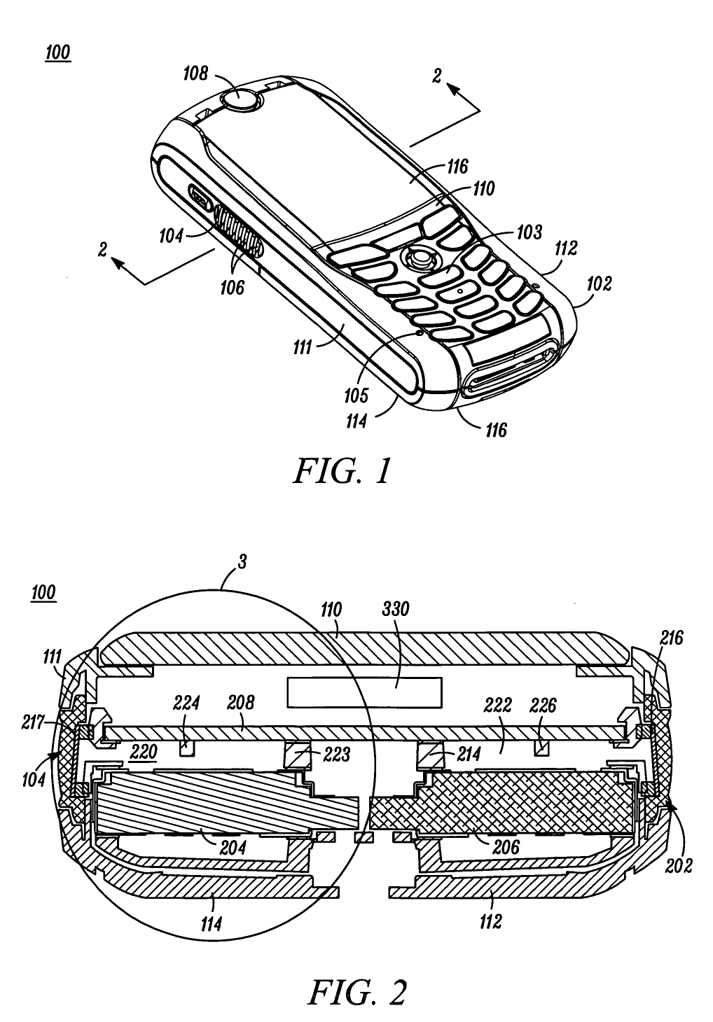

FIG. 1 illustrates a perspective view of an electronic device 100, having a housing 102 generally including a front wall 110, side walls 111, 112, rear wall 114, and bottom wall 116. The front wall 110 of electronic device 100 includes a keypad 103 having multiple keys, which can be selectively actuated, and a display 116 for visually presenting information to a user. The illustrated electronic device 100 additionally includes a microphone port 105 and an ear piece speaker port 108.

The housing 102 includes a port 104 (FIG. 1) in wall 111, which is advantageously an acoustic and light port. The acoustic and light port 104 has openings 106 through which light and sounds are emitted from the housing 100. An acoustic and light port 202 (FIG. 2) is provided in side wall 112. The ports 104 and 202 can advantageously be provided on sidewalls 111 and 112, to provide stereo separation of audio produced by respective associated speakers, as well as to provide appealing side wall light emission. However, it is envisioned that additional or alternative port locations can be provided, such as the front wall 110 of the housing or the bottom wall 116 of the housing.

A speaker, or transducer, 204 is positioned to emit sound into a sealed acoustic chamber 220. The chamber is sealed by printed circuit board 208, speaker 204, member 223 and housing 102. Audio is emitted through port 104. Member 217 is provided across the acoustic and light port 104 to prevent foreign material from entering the acoustic chamber and also to disperse the light from the LED. It is envisioned that the member can be implemented using a screen or felt, and preferably a light screen, such as a white or light colored screen. A dark screen could be used if more limited emissions are desired, but it is envisioned that generally transparent or translucent materials will be utilized.

A speaker, or transducer, 206 is positioned to emit sound into a sealed acoustic chamber 222. The chamber is sealed by printed circuit board 208, speaker 206, member 214 and housing 102. Audio is emitted through port 202. Member 216 is provided across the acoustic and light port 104 to prevent foreign material from entering the acoustic chamber and also disperse the light from the LED. It is envisioned that the member 216 can be implemented in the same manner as member 217, such as by using a screen or felt, and preferably a light screen, such as a white or light colored screen.

The chambers 220, 222 and ports 216, 217 are illustrated as being matched to provide balanced stereo effect with sound emitted via the side walls of electronic device 100. Advantageous acoustic porting that can be employed is described in U.S. patent application Ser. No. 10/337,057, entitled STEREO IMAGING MANIFOLD AND METHOD FOR USE IN A PORTABLE ELECTRONIC DEVICE” filed Jan. 6, 2003 by David S. Brenner et al, the disclosure of which is incorporated herein by reference thereto and included herein as appendix.

Acoustic chamber 220 includes one or more light elements, 224, carried on printed circuit board (PCB) 208. Acoustic chamber 222 includes one or more light elements 226. The light elements 224, 226 can be implemented using any suitable commercially available light source. It is envisioned that an advantageous element is a light emitting diode (LED) having multiple emitters that are controlled to generate any desired color For example, the LED may include independently excited red, green and blue emitters, which are selective excited to generate any desired color.

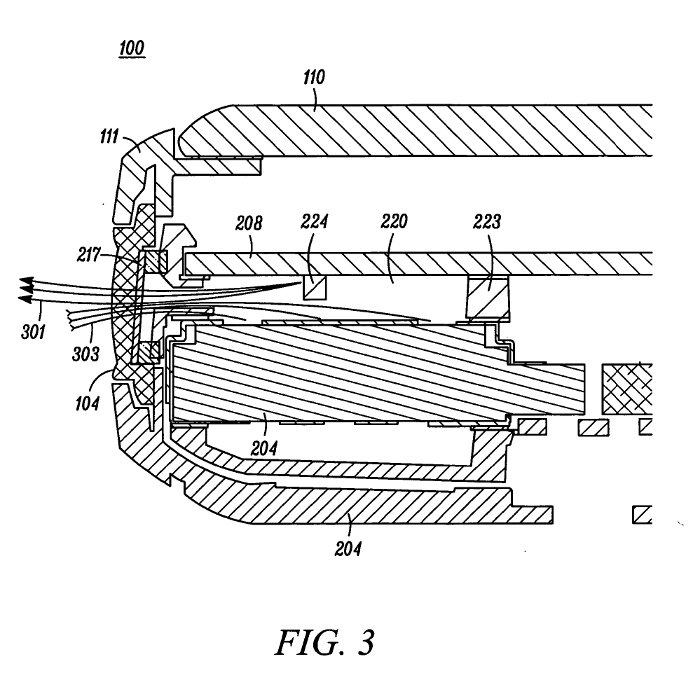

The acoustic chamber and porting method provides an efficient situational lighting system for the device. A light element 224, 226 placed within the acoustic chamber, between the loudspeaker and the acoustic port. The light 301 (FIG. 3) from the light element emits illumination through the same port as the sound 303 from the speakers 204, 206. The position of the light element 224, 226 can be adjusted toward or away from the port 104, 202 to vary the appearance and intensity of the light. This placement can occur during manufacture, when the light element is mounted to PCB 208. The member 216, 217, which can be screen or felt, covers the opening of the acoustic chamber and serves as the light diffuser. The material can be varied to alter the color or transmittance of the member 216, 217. For example, the number of layers of the acoustically neutral material (screen, felt, etc.) can be altered in the number of layers, or materials used, to vary the amount of light dispersion and diffusion. It is envisioned that the member will be alterable by the user by replacing the member, or alterable during manufacture by selecting the member.

The quality of audio performance for loud speakers of a device can be enhanced by the addition of an acoustic chamber for adequate air volume and porting. However, this chamber is often “unused dead space”, and can be large relative to the overall size of the device to create the appropriate amount of air volume and sound path size. It can be seen that the unused space within the acoustic chamber can be advantageously utilized to house one or more light sources, such as a light emitting diode (LED) 224, 226, and uses the sound port that allows sound to escape from the acoustic chamber, to emit the light. This eliminates the need for additional light guides and simplifies the design of the lighting solution.

The lighting can be used to personalize or enhance the user's visual experience, while using the device. For example, the side chambers can be independently controlled for use as different lighting groups, as part of a user experience such as is described in U.S. patent application Ser. No. 10/346,409, entitled “AN AUDIO FILE FORMAT WITH MAPPED LIGHTING EFFECTS AND METHOD FOR CONTROLLING LIGHTING EFFECTS USING AN AUDIO FILE,” filed on Jan. 17, 2003, by Michael S. Caine et. al., the disclosure of which is incorporated herein by reference thereto and attached as an appendix.

It is envisioned that the lighting can be controlled by a variety of means to define color and control light intensity. Note velocity can also be used to define and control the rate of ramp-up and ramp-down of light intensity. A modulation could be defined to control the amplitude of a waveform (sine, square, triangle, etc.) that is superimposed on the volume level. In at least a couple of instances, the light intensity can be controlled by altering the duty cycle of a signal, or the amplitude of the signal, that is supplied to the light sources. Still further, a pitch bend could be used to define and control a substantially continuous shift in the hue displayed for the lighting group, between two relative note (color) values.

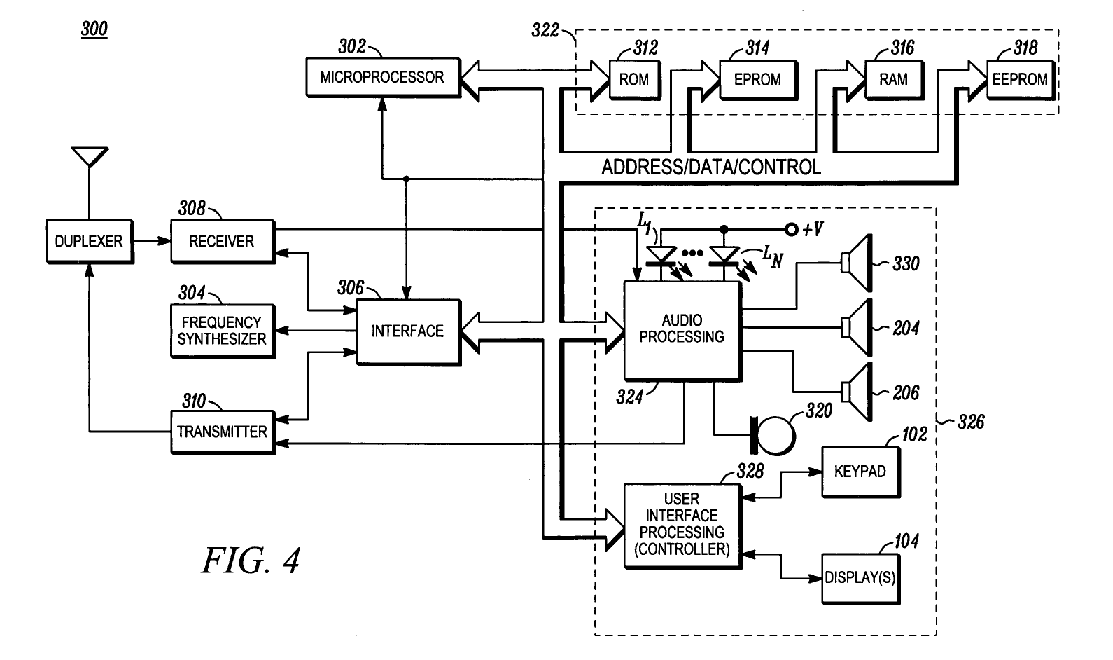

In at least one embodiment, the present invention is incorporated within an electronic device, like a wireless communication device. FIG. 4 illustrates a block diagram of a wireless communication device 300, like a cellular telephone, within which the present invention can be incorporated. Generally, the wireless communication device communicates information via radio frequency signals. In the wireless communication device 300, the particular radio frequency is determined by the microprocessor 302. The particular radio frequency is conveyed to the frequency synthesizer 304 via the interface circuitry 306. Data signals received by the receiver 308 are decoded and coupled to the microprocessor 302 by the interface circuitry 306, and data signals to be transmitted by the transmitter 310 are generated by the microprocessor 302 and formatted by the interface circuitry 306 before being transmitted by the transmitter 310. Operational status of the transmitter 310 and the receiver 308 is enabled or disabled by the interface circuitry 306.

In at least one embodiment, the microprocessor 302, an audio processor 324, and a user interface processor 328 perform many of the processing functions under the control of program instructions stored in a memory section 322. Together, the microprocessor 302, the audio processor 324, and the user interface processor 328 can include one or more microprocessors, one or more of which may include a digital signal processor (DSP). The memory section 322 includes one or more forms of volatile and/or non-volatile memory including conventional read only memory (ROM) 312, electronically programmable ROM (EPROM) 314, random access memory (RAM) 316, or electronically erasable programmable ROM (EEPROM) 318. One skilled in the art will readily recognize that other types of memory are possible.

Identifying features of the wireless communication device are typically stored in EEPROM 318 (which may also be stored in the microprocessor in an on-board EEPROM, if available) and can include the number assignment (NAM) required for operation in a conventional cellular system and/or the base identification (BID) required for operation with a cordless base. Additionally stored in the memory section 322 are prestored instructions for handling the receipt, storage and processing of an audio format file, including audio format files that incorporate lighting control commands, as well as the audio control commands.

Control of user audio, the microphone 320 and the speakers, corresponding to a transducer 330, illustrated in FIG. 3, is controlled by the audio processor or audio processing circuitry 324, which forms part of a user interface circuit 326. The user interface circuit 326 additionally includes the user interface processor or user interface processing circuitry 328, which manages the operation of any keypad(s) 102 and/or display(s) 116. It is further envisioned that any keypad operation could be included as part of a touch sensitive display. In the illustrated embodiment at least some of the lighting sources L1-LN, which may for example be either the individual light emitters in light elements 224, 226 or multiple light elements, can be controlled by the audio processing circuitry 324. However, in some embodiments the audio processing circuitry may transmit commands to other control elements, which more directly control the illumination of the lighting sources. Still further microprocessor 302 or another processor could be used to control the light sources.

In the illustrated embodiment, the earpiece speaker 330 is shown as separate transducer from the stereo speakers 204 and 206, which are all driven from audio processing 324. Those skilled in that art will recognize that the stereo speakers can be used to generate sound for the earpiece port 108, but that this will impact the flexibility of the designer in locating the stereo speakers, or alter the volume requirement for the housing by requiring additional space for sound porting. It is also envisioned that a light source (not shown) can be provided for the speaker port 108, and such port can be provided in a speaker chamber (not shown) for this speaker. Finally, it is envisioned that a speaker could have a large acoustic chamber that has multiple light ports. In such embodiment, some port locations might only pass light, others might port only acoustics by having an opaque port member, while other locations port light and acoustics.

According to another alternate embodiment, it is envisioned that the members 216, 217, can be transparent or translucent to light, but dampen sound passage or otherwise not pass sound. For example, it is envisioned that a separate light ports and acoustic ports can be provided for the acoustic chamber. This distinction might be desirable where sound is to be emitted through one wall of the chamber 220, 222 and light is to be emitted through another wall of the chamber 220, 222.

While the present invention has generally been described in association with a wireless communication device, like a cell phone, radiotelephone, or a cordless telephone, one skilled in the art will readily recognize that the invention is suitable for use with other types of devices. At least a couple of additional examples of other types of devices, where the use of the present invention would be suitable include paging devices, personal digital assistants, portable computers, pen-based or keyboard-based handheld devices, remote control units, an audio player (such as an MP3 player) and the like. Additionally, the invention could find application in televisions, speakers, or other devices using a speaker.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

1. An acoustic chamber and port, comprising:
a loudspeaker;
an acoustic chamber for the loudspeaker;
a port for passing at least light from the acoustic chamber; and
a light source within the acoustic chamber to generate light emitted through the port externally of the chamber.

2. The acoustic chamber and port as defined in claim 1, wherein the port is a both a light port and an acoustic port.

3. The acoustic chamber and port as defined in claim 2, further including a member covering the port.

4. The acoustic chamber and port as defined in claim 3, wherein the member extends across the opening of the acoustic chamber and serves as a light diffuser.

5. The acoustic chamber and port as defined in claim 3, wherein the member comprises a screen or felt for passing sound and light.

6. The acoustic chamber and port as defined in claim 1, further including a member covering the port.

7. The acoustic chamber and port as defined in claim 6, wherein the member extends across the opening of the acoustic chamber and serves as a light diffuser.

8. The acoustic chamber and port as defined in claim 6, wherein the member comprises a screen or felt for passing sound and light.

9. An electronic device comprising:
a housing;
a loudspeaker positioned within said housing;
an acoustic chamber within said housing for the loudspeaker;
a port for passing at least light from said acoustic chamber; and
a light source within said acoustic chamber to generate light emitted through said port to be visible from externally of the chamber.

10. The communication device according to claim 9, wherein the port is an acoustic port and a light port.
